(19) United States
(12) Patent Application Publication
(10) Pub. No.: US 2019/0287163 A1
(43) Pub. Date: Sep. 19, 2019

(54) METHOD AND DEVICE FOR GENERATING OBJECT COORDINATION INFORMATION

(71) Applicant: ALIBABA GROUP HOLDING LIMITED, George Town (KY)

(72) Inventors: Menglei JIA, Hangzhou (CN); Gang HUANG, Hangzhou (CN); Yang CAO, Hangzhou (CN); Keyang SHI, Hangzhou (CN); Jianhong WANG, Hangzhou (CN); Huiling LONG, Beijing (CN); Mao WANG, Hangzhou (CN); Mingxing ZHAO, Hangzhou (CN)

(21) Appl. No.: 16/355,447

(22) Filed: Mar. 15, 2019

(30) Foreign Application Priority Data
Mar. 15, 2018 (CN) 201810215696.8

(51) Int. Cl. G06Q 30/06; G06F 16/955; G06F 3/0484; G06Q 30/02

(52) U.S. Cl. CPC G06Q 30/0643; G06F 16/9558; G06Q 30/0206; G06F 3/04845; G06Q 30/0205; G06F 3/04842

(57) ABSTRACT

Embodiments of the present disclosure provide methods and devices for providing object coordinating information. The method comprises: submitting an object coordinating request to a server, receiving an object coordinating scheme returned by the server. The object coordinating scheme comprises data object information for a plurality of data objects. The plurality of data objects include a first data object that is a primary coordinating object and at least one second data object configured to coordinate with the first data object. The method can also include displaying the object coordinating scheme.

### CROSS-REFERENCE TO RELATED APPLICATION

This application claims the benefits of priority to Chinese Application No. 201810215696.8, filed on Mar. 15, 2018, which is incorporated herein by reference in its entirety.

### TECHNICAL FIELD

The present disclosure generally related to the field of identifying data objects, and in particular, to methods and devices for generating object coordination information.

### BACKGROUND

The amount of information being processed and stored on the Internet is rapidly increasing as technology advances present an ever-increasing ability to generate and store data. Correspondingly, users of the Internet are provided with more and more choices across a wide array of entities, thereby making it difficult to search for and identifying objects of interest. Moreover, when it comes to locating multiple related objects, the user may find it too difficult and time consuming to coordinate these objects across different web platforms.

### SUMMARY

Embodiments of the present disclosure provide methods and devices for providing coordinating information.

The embodiments can include a method for providing object coordinating information, comprising: submitting an object coordinating request to a server, receiving an object coordinating scheme returned by the server, wherein the object coordinating scheme comprises data object information of a plurality of data objects, and the a plurality of data objects include a first data object being a primary coordinating object and at least one second data object being configured to coordinate with the first data object, displaying the object coordinating scheme.

The embodiments can include a method for providing object coordinating information, comprising: receiving an object coordinating request sent by a client, and returning an object coordinating scheme to the client, wherein the object coordinating scheme comprises data object information of a plurality of data objects, and the plurality of data objects comprises a first data object being a primary coordinating object and at least one second data object configured to coordinate with the first data object.

The embodiments can include a method for generating an object coordinating scheme, comprising: determining a first data object, obtaining feature information of the first data object, selecting in a data object information database at least one second data object with feature information which matches the feature information of the first data object using object coordinating model, and generating an object coordinating scheme based on information of the first data object and information of the second data object.

The embodiments can include a method for generating an object coordinating template, comprising: obtaining training samples, and the training samples comprising a plurality of object coordinating schemes, and each object coordinating scheme comprising a plurality of data objects, obtaining feature information of the data object in the object coordinating scheme, obtaining coordinating information among the feature information of the data objects based on the feature information of the data objects in the object coordinating scheme, and generating an object coordinating model based on the coordinating information.

The embodiments also include a device for providing object coordinating information, comprising: one or more memories storing a set of instructions; and one or more processors configured to execute the set of instructions to cause the device to perform: submitting an object coordinating request to a server, receiving an object coordinating scheme returned by the server, wherein the object coordinating scheme comprises data object information of a plurality of data objects, and the plurality of data objects include a first data object being a primary coordinating object and at least one second data object configured to coordinate with the first data object, and displaying the object coordinating scheme.

The embodiments also include a device for providing object coordinating information, comprising: one or more memories storing a set of instructions; and one or more processors configured to execute the set of instructions to cause the device to perform: receiving an object coordinating request sent by a client, and returning an object coordinating scheme to the client, wherein the object coordinating scheme comprises information of a plurality of data objects, and the plurality of data comprise a first data object being a primary coordinating object and at least one second data object configured to coordinate with the first data object.

The embodiments can also include a device for generating an object coordinating scheme, comprising: one or more memories storing a set of instructions; and one or more processors configured to execute the set of instructions to cause the device to perform: determining a first data object, obtaining feature information of the first data object, selecting in a data object information database at least one second data object with feature information which matches the feature information of the first data object using an object coordinating model, and generating an object coordinating based on information of the first data object and information of the second data object.

The embodiments can also include a device for generating an object coordinating template, comprising: and one or more processors configured to execute the set of instructions to cause the device to perform: obtaining training samples, and the training samples comprising a plurality of object coordinating schemes, and each object coordinating scheme comprising a plurality of data objects, obtaining feature information of the data object in the object coordinating scheme, obtaining coordinating information among the feature information of the data objects based on the feature information of the data objects in the object coordinating scheme, and generating an object coordinating model based on the coordinating information.

### BRIEF DESCRIPTION OF THE DRAWINGS

The accompanying drawings described herein are used to provide further understanding of the present disclosure and constitute a part of the present disclosure. Exemplary embodiments of the present disclosure and descriptions of the exemplary embodiments are used to explain the present disclosure and are not intended to constitute inappropriate limitations to the present disclosure. In the accompanying drawings:

FIG. 1 is a schematic diagram of an exemplary system for generating object coordinating information according to embodiments of the present disclosure;

FIG. 2 is a flowchart of an exemplary method for generating object coordinating information according to embodiments of the present disclosure;

FIG. 3 is a flowchart of another exemplary method for generating object coordinating information according to embodiments of the present disclosure;

FIG. 4A to FIG. 4F are schematic diagrams of object coordinating model interfaces according to embodiments of the present disclosure;

FIG. 5 is a flowchart of an exemplary method for generating a object coordinating scheme according to embodiments of the present disclosure;

FIG. 6 is a flowchart of an exemplary method for generating an object coordinating template according to embodiments of the present disclosure;

FIG. 7 is a schematic diagram of an exemplary device for generating object coordinating information according to embodiments of the present disclosure;

FIG. 8 is a schematic diagram of an exemplary device for generating object coordinating information according to embodiments of the present disclosure;

FIG. 9 is a schematic diagram of an exemplary device for generating a object coordinating scheme according to embodiments of the present disclosure;

FIG. 10 is a schematic diagram of an exemplary device for generating an object coordinating template according to embodiments of the present disclosure;

FIG. 11 is a schematic diagram of an exemplary electronic equipment according to embodiments of the present disclosure.

### DETAILED DESCRIPTION

To facilitate understanding of the solutions in the present disclosure, the technical solutions in some of the embodiments of the present disclosure will be described with reference to the accompanying drawings. It is appreciated that the described embodiments are merely a part of rather than all the embodiments of the present disclosure. Consistent with the present disclosure, other embodiments can be obtained without departing from the principles disclosed herein. Such embodiments shall also fall within the protection scope of the present disclosure.

The embodiments of the present disclosure can provide several advantages. For example, an object coordinating scheme can be provided to the user, wherein, the object coordinating scheme can comprise information of a plurality of data objects including a first data object that is the primary coordination object as well as at least one second data object to coordinate with the first data object. The scheme can help the user to obtain knowledge about the object coordination, which helps the user to coordinate data objects or make better decisions.

According to the embodiments, a first data object can be a data object acquired or to be acquired by a user, as such, it can target data objects to coordinate what the user has already acquired. To assist with the coordination, a coordinating scheme can be developed.

In a coordinating scheme, an object coordinating model can also be generated based on the large number of known coordinating schemes. When a specific first data object is needed to make a match, the feature information of the first data object can first be extracted and then, based on the object coordinating model and the data object information database, determine at least one second data object that can be coordinated with the first data object.

Moreover, in the coordination process, other information can also be considered in addition to considering the basic feature information of the objects, thereby providing the user a more accurate and effective coordinating scheme.

Embodiments of the present disclosure provide an object coordination scheme, which can be integrated in programs provided by current online systems (e.g., “Tmall”, “Mobile Taobao”, etc.). Users of such systems can receive recommendations of coordinating information provided by the programs when shopping online to assist with better shopping decisions. The object coordinating function can also be provided through a separate program. To associate the separate program with online shopping information or needs of a user, the programs can be integrated with online systems. With the user's authorization, the programs can obtain data such as historical order records, bookmarks, follows, browsing records, or user personalized preference information. The data can be used to generate coordinating information for the user.

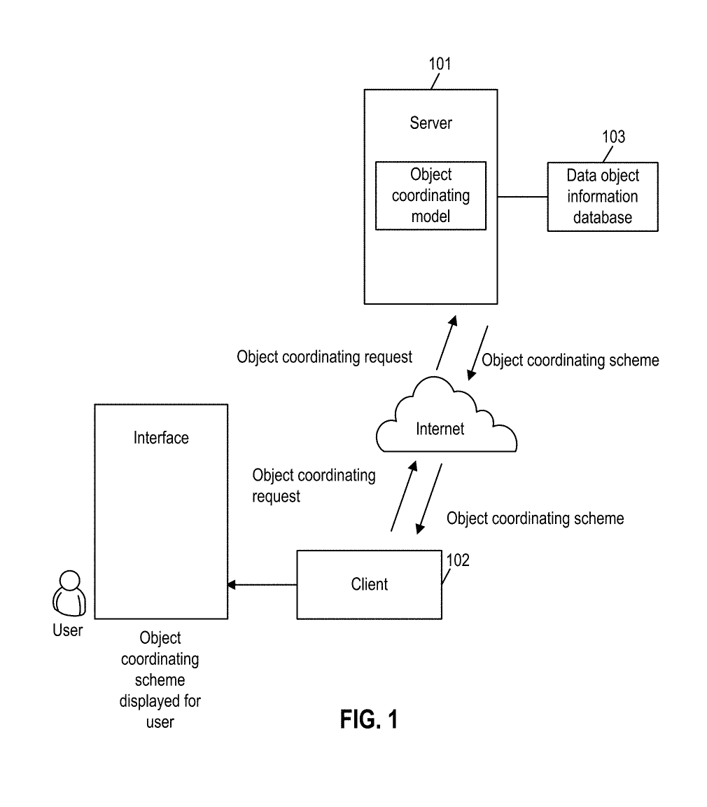

No matter whether the programs function dependently or incorporate an online system, the programs can include a client end and a server end (referring to FIG. 1). The client end is mainly used to interact with the user and display a specific coordinating interface, and the server end is mainly used to provide specific coordinating schemes. The server end can also maintain an object coordinating model and the related data object information database. The object coordinating model can be built by learning several million or more existing coordinating schemes. A coordinating data object can be selected in a data object information database to coordinate with a data object when the data object is an input. Moreover, creative expressions in the style description information can also be analyzed in the learning process and the analysis results can be saved. Specifically, when coordinated data objects are selected for a certain type of data object, the style description information corresponding to the coordinating scheme can also be provided. It is appreciated that the server end can generate a specific coordinating scheme before receiving a request. When the server receives a coordinating request from the user end, the server can directly return the coordinating scheme to the user end. For example, the server end can select at least one primary data object from the user's activity history, and then determine at least one other data object to generate a coordinating scheme based on the object coordinating model. Specifically, after receiving the client-end coordinating request, the server can directly return the pre-generated coordinating scheme to the client end. Or, after receiving the client-end request, the server can regenerate a specific coordinating scheme and return it to the client end. For example, it can be a data object selected by a user that needs to be coordinated, and the coordinating request is sent to the server. The server then targets the specific data object of the client-end request and selects another data object that can coordinate with the data object, thereby generating a coordinating scheme.

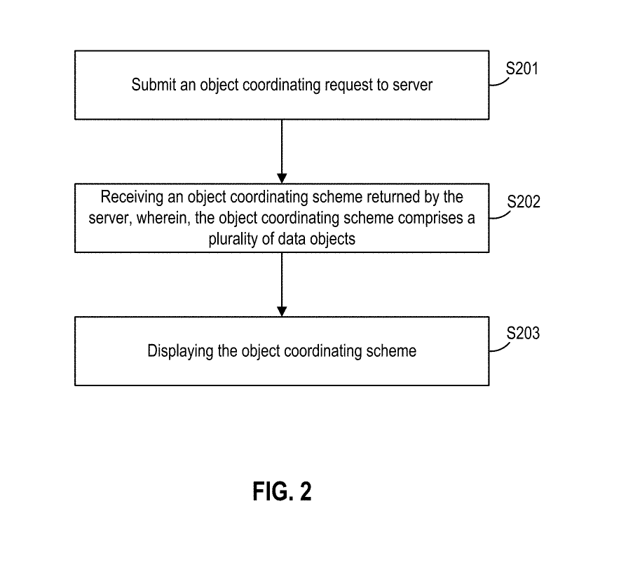

FIG. 2 is a flowchart of an exemplary method for generating object coordinating information according to embodiments of the present disclosure. The method can specifically comprise:

In step S201, submitting the object coordinating request to the server.

In some embodiments, an input used to initiate the coordinating request is provided in client-end user interface. The user can initiate a specific object coordinating request through this input. In one example, the coordinating request can be initiated directly, that is, a data object does not need to be specified, and the user can initiate the coordinating request without target data objects. In another example, the user can also designate target data objects when sending the coordinating request. For example, a certain user may be interested in a certain data object. Before deciding to acquire the data object, the user wants to learn the which items the data object can be paired with. The user can then designate the data object as the target data object and initiate the coordinating request to the server. In some embodiments, input interface can be provided to the coordinating requests in both examples. With regards to the coordinating request, a selectable item such as an input box to input information such as the data object image can be provided in the user interface. Therefore, the data object images can be carried in the coordinating request and submitted to the server.

In step S202: Receiving the object coordinating scheme returned by the server, wherein, the coordinating scheme comprises data object information for multiple types, and the data object information for multiple object types is comprised of a first data object that is the primary coordinating object as well as at least one second data object configured to coordinate with the first data object. After the server receives the client-end coordinating request, it can provide a specific object coordinating scheme to the client, and the object coordinating scheme can include information of a plurality of data objects, which include a first data object that is the primary coordinating object as well as at least one second data object to coordinate with the first data object. Wherein, if data object information is not carried in the coordinating request, then a first data object can be selected by the server, and if data object information is carried in the coordinating request, then the data object carried in the coordinating request is specified as the first data object.

When the first data object is specified by the server, a user may have stronger needs for acquired data objects. the first data object can be selected from the data objects already acquired by the requesting user. Coordinating scheme information for acquired data objects can be provided to the user. The user can be provided choices when the user prefers acquired data objects. If there are a large number of previously acquired data objects, the data objects can be filtered. For example, one or more data objects recently acquired by the user can be selected as first data objects and schemes can be provided for each of the first data object. In one example, a specific first data object can be selected by taking into consideration the current season and the current weather. For example, if the current season is winter, then appropriate data objects worn in winter can be selected from the user's previously purchased data objects to provide a coordinating scheme. Or, if the current weather is windy and cold, then appropriate data objects worn in low temperature environments can be selected from the user's previously purchased data objects to provide a coordinating scheme. If there is no or too few data objects acquired data objects, the first data object can be specified based on other information. For example, a first data object can be selected from data objects that the user has bookmarked, followed, or recently browsed. In one example, selection can still be made specifically based on the current season or weather conditions. A data object with a high popularity level can be selected as the first data object. The server can determine popularity levels of the data objects by obtaining information on how each user uses the object coordinating function, which data objects are used to initiate object coordinating including customized object coordinating.

A coordinating scheme can be provided for the first data object when a first data object is determined. At least one second data object can be selected from the data object information database to form a complete coordinating scheme. In one example, the coordinating schemes employed by other users (especially “coordinating expert” users or “professional” users) can be queried. If a certain coordinating scheme includes the current first data object, then this coordinating scheme can be specified as the coordinating scheme to be recommended. In some embodiments, the coordinating history of an “expert” or “professional” is required, and if a certain first data object has not been coordinated by an “expert” or “professional” user, then a coordinating scheme cannot be provided for the current user. As shown in FIG. 1, according to some embodiments, an object coordinating model can be pre-generated. The knowledge database can be generated by learning a plurality of coordinating schemes provided by “expert” or “professional” users. The learned knowledge can be modelized. Therefore, a corresponding coordinating scheme can be provided for any first data object.

In one example of model learning and training, the object coordinating schemes distributed by object coordinating experts on the Internet can be collected through WebCrawler. The object coordinating schemes already coordinated by coordinating experts can also be manually collected to act as training samples. Based on an artificial intelligence algorithm, a large number of collected coordinating schemes are learned, and then coordinating relationships between the feature information can be generated, ultimately establishing a database. The database is dedicated to storing these coordinating relationships. The database is denoted as a coordinating model. The knowledge database can be allocated by the server. The knowledge base can also be updated. For example, newly collected training samples can be input into a model trainer to perform learning again. Therefore, new training samples can be collected periodically, thereby regularly updating the knowledge database.

In some embodiments, specifically while performing the model training process, the feature information of each data object in each specific coordinating scheme can be analyzed. In the coordinating model acquired by training, the feature information of a first data object can be used as a model input. The output can be at least one second data object. In one example, where clothing is considered the data object to be coordinated and the object coordinating scheme is a clothing matching scheme, the feature information can comprise basic attributes of the clothing design such as clothing type (jacket, overcoat, pants, dress, shirt, shoes), version (e.g. slim fit), sleeve type, collar, length, thickness, popular elements, type of pants, material, color, style, etc.

In some embodiments, the training samples can first be obtained. Training samples include multiple known object coordinating schemes, and the known object coordinating schemes include multiple data objects. The feature attribute information of the data objects in the known coordinating schemes are obtained; then, based on the feature attribute information of the data objects in the object coordinating schemes, information about the coordinating relationship between the feature attributes is generated; finally, an object coordinating model based on the coordinating relationship information is generated.

After the object coordinating model is obtained, and a first data object is determined, the feature information of the first data object can first be obtained. Based on the feature attribute information of the first data object input into the coordinating model, the model can output at least one second data object that can be coordinated with it. It is appreciated that another set of input information of the coordinating model can be each set of data object information in the known data object information database. To facilitate calculation, the feature attribute information of each of the data objects in the known coordinating scheme can be saved in advance in the data object information knowledge base. The model can select at least one second data object that can coordinate with the current first data object from the data object information database based on the specific coordinating information.

Specifically, the server can build an index with another dimension for the data objects in the data object knowledge database to facilitate faster search efficiency. Specifically, the server can recognize the data object information in the data object information database, obtain the feature attributes of the data object and create an index based on the feature attributes; then the server, in the actual search, obtains a second data object that meets the conditions from the data object information database based on the index.

In some embodiments, the server can classify data objects having the same or similar feature attributes as one type and establish an index with the feature attributes as the baseline. Specifically, a Hash index or Btree index format can be used to establish the index, thereby accelerating the server data object search function. The server does not need traversal search such that consumption of the server's resources is reduced.

In some embodiments, where clothing is considered the data objects to be coordinated, the object coordinating scheme can be a clothing matching scheme, the server pre-marks the clothing type data object in the data object information database so that the clothing type data object has weather tags or occasion tags. The weather tags can be used to identify information as the weather temperature and season applicable of the clothing type data object. The occasion comprises wedding banquets, birthday banquets, at home, travel, work, exercise, etc. The weather tags and occasion tag can act as attributes of the clothing type data object and be sorted in the data object information database. The server can make a determination based on the user's geographical location and weather forecast. The occasion information can be specified by the user. For example, the server can provide selectable items such as occasion options through the client-end. The user can select an occasion through the selectable items. For example, if the user needs to attend a friend's wedding banquet, the user can select the occasion as wedding banquet; if the user needs to attend a parent's meeting, then they can select the occasion as parent's meeting, etc. The server can also make more accurate matching recommendations using the combined weather/occasion tags when generating a matching scheme.

For example, the first data object is a ladies white long-sleeved pointed-collar slim cotton shirt. The server targets clothing feature attributes extracted from the first data object, including: type: shirt, style: slim, color: white, material: cotton, sleeve type: long-sleeve, collar type: pointed, etc. Based on the pre-established matching relationship information, the attributes of other items that can match the first data object can include:

Item 1: type: skirt, style: pleated, color: black, material: cotton and linen.

Item 2: type: jacket, style: contoured, color: thousand-bird pattern, material: cotton.

Item 3: type: shoes, style: flat, color: white, material: canvas.

In addition, based on the current weather situation (including season, meteorological characteristics, etc.) and information needed by the user such as occasion, the required weather tags and occasion tags can also be determined; for example, weather tags include autumn, wind and falling temperatures, and the occasion tag can include “parent's meeting”. The tag information can also be added to the clothing feature attributes of each required item, to select a second data object, the weather tag or occasion tag described above can also be considered. Then, a data object matching each item described above can be respectively selected from the data object information database to act as a second data object that can match with the first data object.

Moreover, in some embodiments of this disclosure, different spending power and brand preferences of the users are taking into consideration. The server, when selecting a second data object, can also select a second data object that matches the brand and price information of the first data object to provide the user a more precise clothing matching scheme. Information such as prices and brand positioning of the data object can also be saved as expanded feature attributes of a data object. Specifically, the server can search for a second data object with matching clothing feature attribute information from the data object information database based on the object coordinating relationship. The information can include price, color, style, and brand. Information such as spending power and brand preferences can be selected or input by the user through the client end. The server can also analyze user information such as spending power and brand preference based on the user's purchasing history, browsing records, and bookmark history. The server can also determine user spending power and brand preference information based on user information saved in the system. Moreover, the server can also directly determine user information such as spending power and brand preference, etc., based on the price point and brand preference positioning of the first data object.

For example, the user purchases a piece of 600-yuan, A-brand sportswear through the client end. When the client end sends this sportswear matching request to the server, the request contains the price of 600 yuan and the brand name NIKE. The server can also automatically recognize the brand name from the image of the sportswear and search for prices from the database. After the server receives the clothing matching request sent by the client end, the server can perform clothing matching. when a second data object is selected, in addition to considering the matching relationship, price matching and expanded brand attribute matching also need to be considered. The price matching specifically refers to that the closer the prices, the higher the matching. The brand matching of the two items specifically refers to matching of the merchandise brand positioning. For example, whether they both are classified as a luxury brand, light luxury brand, cheap brand, etc. Based on this example, the price of the second data object searched by the server can be moderately priced, and the brand can be a brand in the same category as A brand, thereby providing a clothing matching scheme for the user that satisfies the user's clothing preferences.

The specific expanded attribute can also include attributes such as merchandise time on market, merchandise designer, and merchandise applicable age.

It is appreciated that the coordinating scheme returned by the server can mainly include image information of the data object included in the coordinating scheme. This image information can be obtained from the data object information database. In the same coordinating scheme, the size of the image for each different category of data object can be different. After the server has generated a specific coordinating scheme, it can also set up the size of each image and the sequence between the images to form display results similar to a photo collage. In some embodiments, the server can save multiple templates and select photo collaging templates based on different quantity, and style of the data objects included in the coordinating scheme, and then determine the size of each image and the layout of each image.

In addition to image information, address link information to detail information and detail pages of the data object can also be provided in the coordinating scheme. When a user searches for a specific coordinating scheme, they can also view the information described above. When the client end is displaying the coordinating scheme, the client does not necessarily in the initial status display the detail information and detail page link information.

In some embodiments, text descriptions of coordinating style and creative expressions can also be included in the collected training samples. During the model training process, analysis of the text description information can be performed, and the analysis results saved. when a specific coordinating scheme is the generated for the first date object, style description information can also be output. For example, where clothing is considered the data objects to be coordinated and the coordinating scheme is a clothing matching scheme, the corresponding style description information of a certain matching scheme can comprise: “Fresh and clean, warm and comfortable, fashionably loose, sweet and cute ladies' style”, etc. There may be multiple data objects that meet the conditions when selecting a second data object from the data object information database. For example, there may be multiple pants that have the attribute features of “type: skirt, type: pleated, color: black, material: cotton and linen”. One of the multiple pairs of pants meeting the conditions can be selected to add to the matching scheme. The other pants can also be matched with the current data object. In order to provide the user with more choices, in some embodiments, the clothing matching scheme provided by the server can also comprise information of at least one replaceable data object related to the clothing type data object. The client end can also display the information of the replaceable data object so that the user can manually modify the matching scheme to generate a self-defined matching scheme.

In step S203 the coordinating matching scheme is displayed.

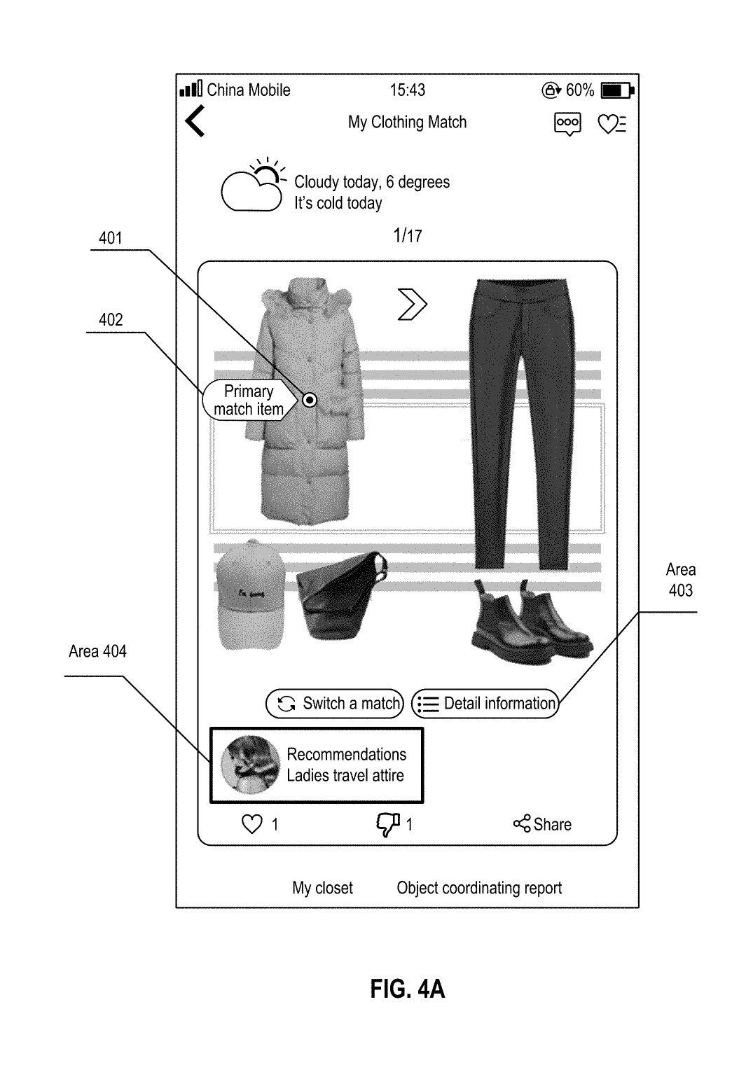

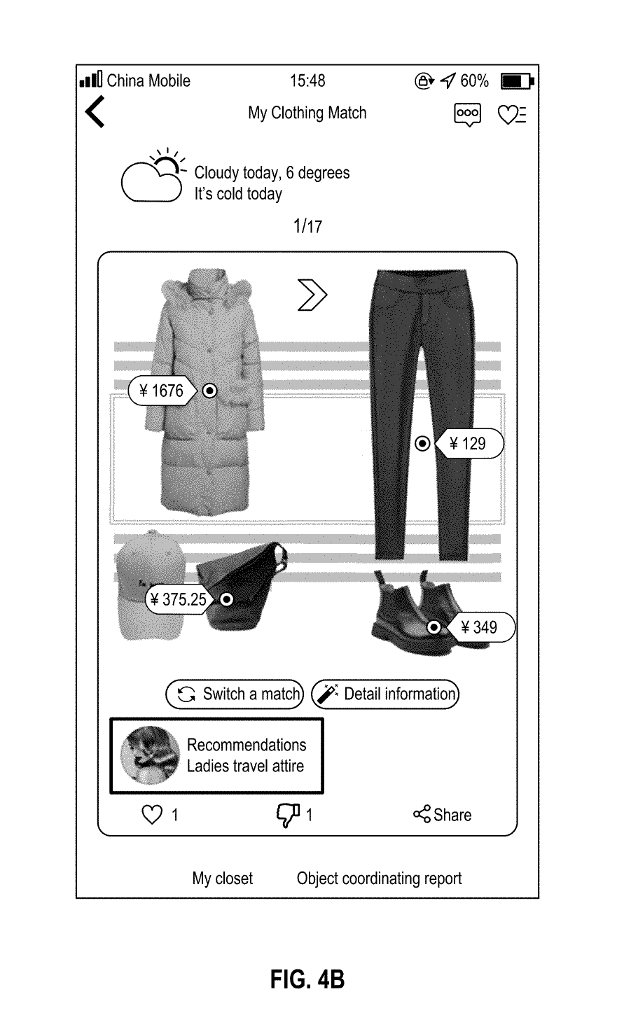

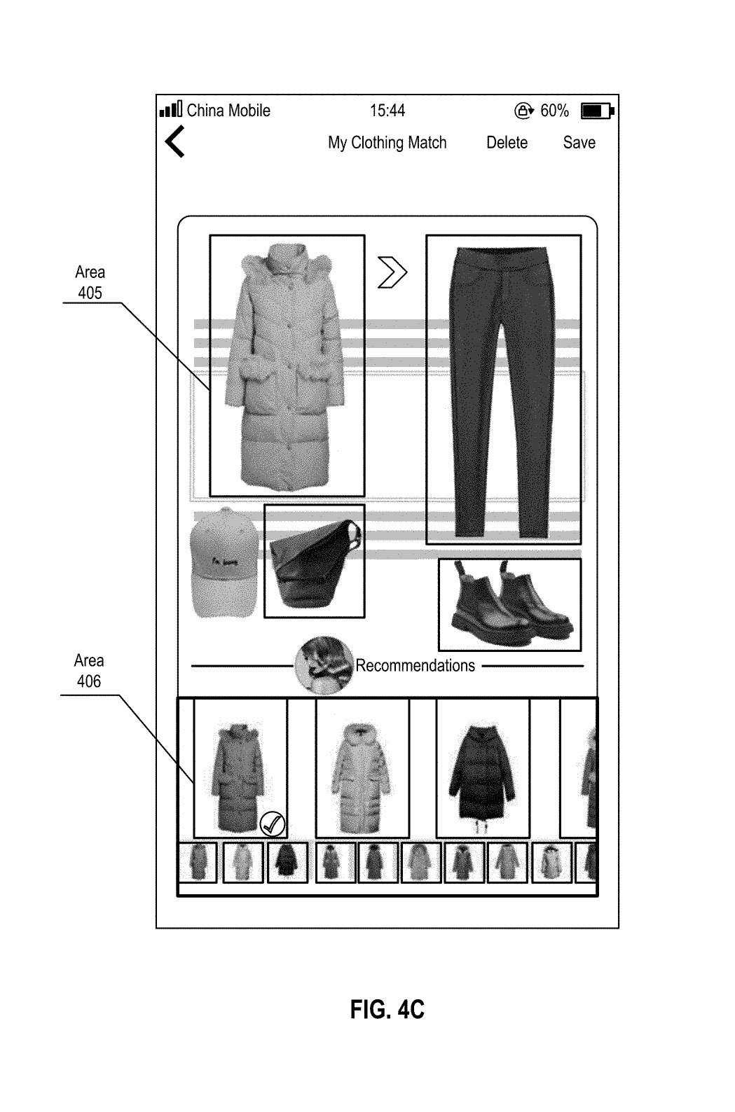

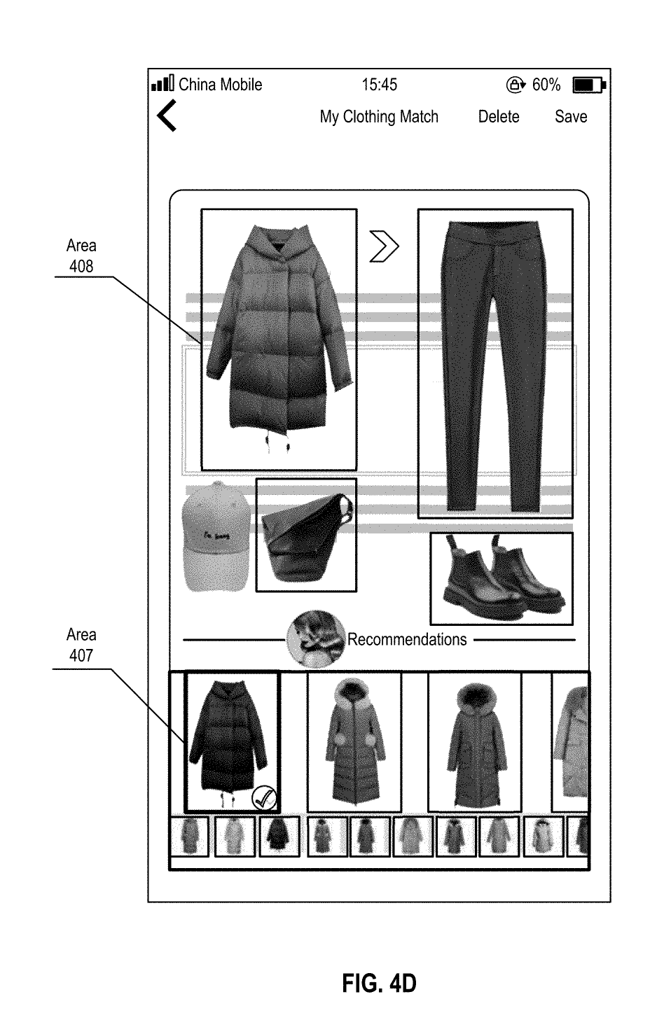

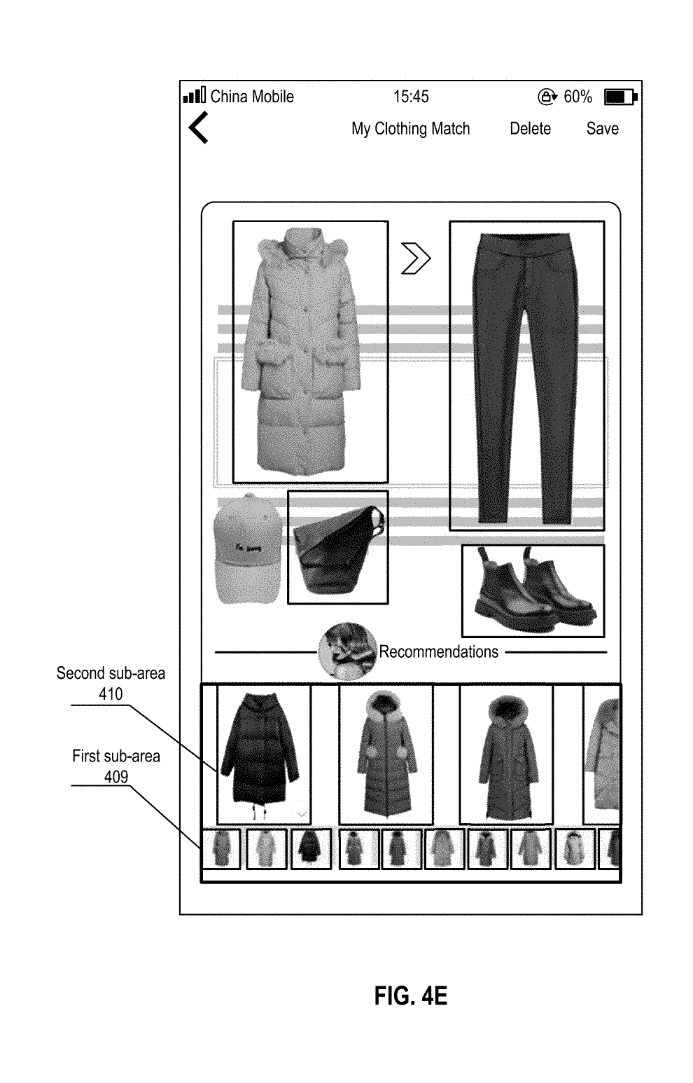

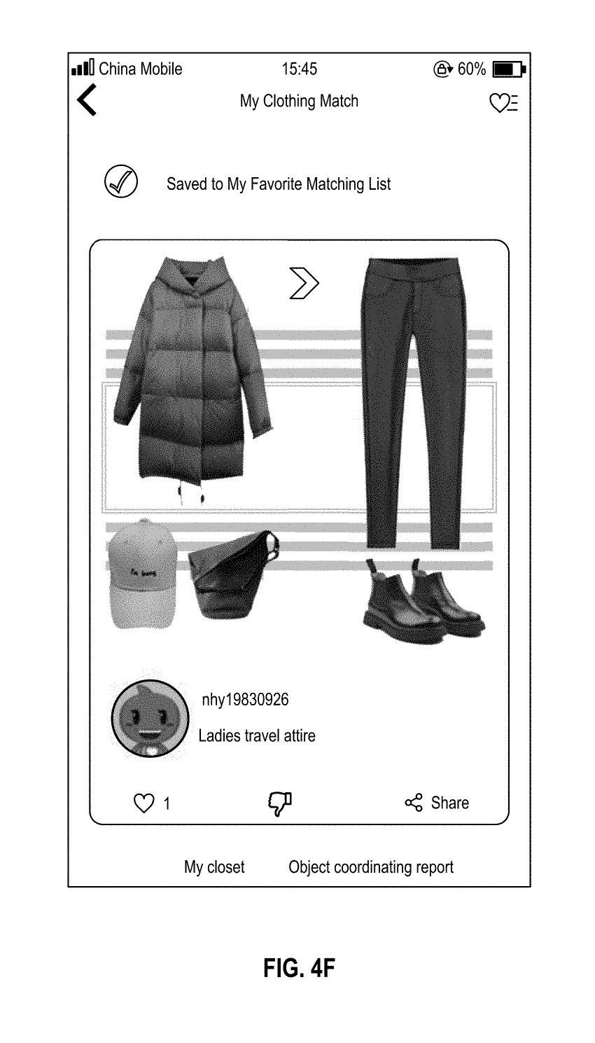

After the client end receives the coordinating scheme information returned by the server, the specific coordinating scheme information can be displayed in the specific coordinating interface. In some embodiments, the specific coordinating scheme provided by the server can primarily comprise information for each data object image. The server can perform layout arrangement of the image information in advance so that the client end displays each image according to the layout arrangement. For example, as shown in FIG. 4A, a matching scheme is displayed, wherein it comprises multiple clothing type data objects and, such as down garments, long pants, backpacks, hats, and shoes. The size dimensions of each data object and the layout of each image can both be pre-specified by the server. As shown in FIG. 4A, the matching scheme as displayed with “ 1/17” in FIG. 4A is one of 17 matching schemes provided to the user. The user can switch views to other matching schemes by swiping left and right or up and down.

As shown in the matching scheme in FIG. 4A, down garment 401 is the main object, that is, the first data object, and each of the other data objects are second data objects. In some embodiments, the first data object can also be displayed. For example, messages such as the “Primary match item” 402 in FIG. 4-1 is provided to suggest this data object as the first data object. The first data object is usually the clothing data object already purchased by the current user. It can also be the data object specified by the user.

The matching scheme provided by the server end can also comprise style descriptions of a specific matching scheme. In the process of displaying the matching scheme, this style description information can also be displayed. For example, as shown in area 404 in FIG. 4A, in some embodiments, message including a portrait or nickname can also be provided. For example, the nickname can be “Xiaofan”. The portrait or the nickname mentioned above can correspond to the specific “product” of the provided clothing matching.

In some embodiments, the matching scheme provided by the server can also provide summary information contained in the clothing type data object, such as price and brands. In the initial status, only the data object image can be displayed in the matching interface. A first selectable item is provided for the user to view the summary information of the clothing type data object in the matching scheme. For example, as shown in area 403 in FIG. 4A, a “item information” button can be provided so that the user can view the specific data object summary information by clicking the first selectable item. For example, after clicking “item information” in the matching scheme in FIG. 4A, the user can jump to the interface shown in FIG. 4B. Information such as price for the specific clothing type data object can be displayed.

The server can also provide the clothing type data object in the clothing matching scheme as well as the link address information for the corresponding details page. The client end can display the summary information of the clothing type data object can set a status of an area as operable. The image of the clothing data object is displayed in the area. When the area is operated, the details page of the data object is displayed. For example, when the image of the down garment in FIG. 4B is clicked, then the user can jump to the details page of this down garment for display.

In some embodiments, the client can display replaceable data objects because the clothing matching scheme provided by the server can also include information of at least one replaceable data object related to the clothing type data object. The same matching scheme usually comprises a plurality of data objects, each data object can comprise a plurality of replaceable data objects. In some embodiments of this disclosure, in the initial display of the matching interface, replaceable data object information can temporarily not be displayed. The interface only displays the matching scheme provided by the server. The specific data object image information in the matching scheme can be in operable status. When one of the target data objects is selected, a candidate display area can be provided in the matching interface. The information for the at least one replaceable data object related to the displayed target data object can be provided in the candidate display area. When one of the replaceable data objects is selected, the replaceable data object information being selected is used to replace the image of the target data object e.

As shown in FIG. 4C, When the user clicks the down garment shown in area 405, a candidate display area can be established in the area 406 of the matching interface. In this area, the replaceable data object information for down garment shown in area 405 is displayed. The data object information in the displayed matching scheme information can similarly be displayed in image format. In addition, when displaying the candidate display area, a thumbnail image can be displayed, and when a data object corresponding to the replaceable matching scheme is selected, an enlarged image of the replaceable data object is displayed in the matching scheme. The replaceable data object information in the clothing matching scheme can also comprise: the thumbnail and the enlarge image of the replaceable data object. The size of the enlarged image can be determined based on the size of the image of the data object related to the replaceable data object in the matching scheme. The thumbnail of at least one replaceable data object related to the target data object can be displayed in the candidate display area. After a certain replaceable data object is selected, the enlarge image of the replaceable data object in the selection can be used to replace the target data object image in the matching scheme. As shown in FIG. 4D, after the replaceable data object shown at area 407 is selected, the image of the replaceable data object is displayed at area 408.

The area of the candidate display area is usually limited. The thumbnail provided by the server end for the replaceable data object can include a first thumbnail image and a second thumbnail image, wherein, the first thumbnail image size is smaller than the second thumbnail image. As shown in FIG. 4E, the candidate display area established by the client end can include a first sub-area 409 and a second sub-area 410. A first thumbnail of the replaceable data object is displayed in the first sub-area; in the second sub-area, some of second thumbnail images of the replaceable data objects are displayed in the second sub-area. When the second sub-area is preset, second thumbnail images of the other replaceable data objects are displayed in the second sub-area. The data object information displayed in the first sub-area and the second sub-area can be the same, except that more replaceable data objects can be displayed in the first sub-area because the size of the first thumbnail is smaller than the second thumbnail so the recognizable level of the first sub-area is lower than that of the second sub-area. The user can select a replaceable data object by selecting the thumbnails displayed in the second sub-area. The user can determine if there are more replaceable data objects via the information displayed in the first sub-area. If so, second thumbnails of the replaceable data objects can be viewed by swiping left and right or up and down in the second sub-area. In some embodiments, when a target replaceable data object in the second sub-area is selected, a second thumbnail image in the second sub-area of the target replaceable data object and a first thumbnail image in the first sub-area to selection status can be placed in selected status.

A second selectable item for saving the replaced matching scheme can be provided. For example, the “Save” button displayed in the upper right corner of FIG. 4E is provided. When a storage request for the replaced matching scheme is received through the second selectable item, the replaced matching scheme information can be submitted to the server such that it can be saved in the storage space of the user. For example, as shown in FIG. 4F, it can be stored in the “My favorite clothing matching list”.

In some embodiments, the first data object can be a data object for the clothing type purchased by the user, or a data object the user wants to purchase. The matching scheme can be provided for purchased data objects with which the user does not know how to match. The user can match clothing using similar items, or purchase matching items again. In a situation where the user hesitates to purchase a data object because the user does not know how to match the data object with other items, providing a clothing matching scheme helps the user to make decision. The user may purchase a second data object to match with the first data object based on suggested matching scheme, which leads to increasing sales and visiting hits of the second data object.

A clothing matching model can also be generated based on the large number of known matching schemes. When a specific first data object is needed to make a match, the clothing feature information can first be extracted and then, based on the clothing matching model and the data object information database, determine at least one second data object that can match with it. Automated matching recommendations are provided in place of manually provided clothing matching.

Moreover, in the matching process, information such as weather, required occasion, user spending power, and preferred brands can also be considered in addition to considering the basic feature attributes of the clothing (including type of clothing, style, version, material, etc.), thereby providing the user an accurate and effective matching recommendation scheme.

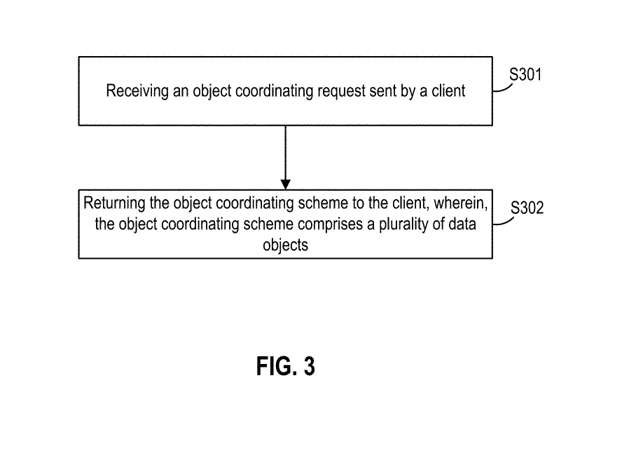

FIG. 3 is a flowchart of another exemplary method for generating object coordinating information according to embodiments of the present disclosure. The method can specifically comprise:

In step S301: receiving the coordinating request sent by the client;

In step S302: returning the coordinating scheme to the client, wherein, the coordinating scheme comprises information for a plurality of data objects, and the plurality of data objects is comprised of a first data object that is the primary coordinating object as well as at least one second data object configured to coordinate with the first data object.

In some embodiments, the coordinating scheme can be established in advance. or after receiving the client-end request. In either situation, the server can first determine a first data object and then determine at least one second data object that can be coordinated with the first data object and generating an object coordinating scheme.

The first data object can be specified based on the data object acquired by the requester user connected to the client. The first data object can also be determined based on the data information carried in the coordinating request. Moreover, the first data object can also be determined based on the data object information of popularity levels that meet certain conditions.

The server obtains the attributes from the first data object to determine at least one second data object that can coordinate with the first data object. The server selects at least one second data object with the feature attribute information which matches the information of the first data object based on the feature attribute information of the first data object and the preset coordinating model.

In some embodiments, where clothing is considered the data objects to be coordinated and the coordinating scheme is a clothing matching scheme, a weather tag with the clothing type data object can also be saved in the data object information database. At least one second data object with the clothing feature which matches the weather condition information can be selected based on the weather condition information of the geographical location of the user on the client end.

In some embodiments, an occasion tag for the clothing type data object is also saved in the data object information database. At least one second data object with the clothing feature attribute information which matches the required occasion information of the 7 user is selected.

Price tags and brand positioning tags for the clothing type data object can also be saved in the data object information database. The server can select at least one second data object with the clothing feature which matches one of the price point or brand positioning information based on the required price or brand positioning information of the user on the client end.

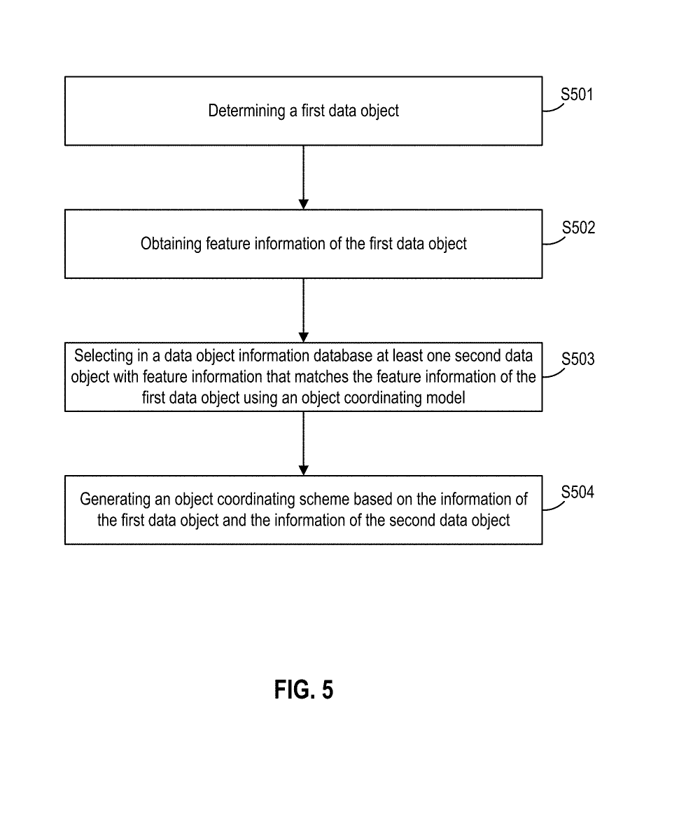

FIG. 5 is a flowchart of an exemplary method for generating an object coordinating scheme according to embodiments of the present disclosure. This method specifically can comprise:

In step S501: Specifying a first data object;

In step S502: Obtaining the feature attribute information of the first data object;

In step S503: Based on the feature attribute information of the first data object and the preset coordinating model, choosing at least one second data object with coordinating relationship to the feature attribute;

In step S504: Generating a coordinating scheme based on the first data object and the second data object information. For example, the server can create a photo collage with the image of the first data object and the image of the second data object using a photo collage template to generate the coordinating scheme.

In some embodiments, the server can provide a photo collage template library. The photo collaging template library comprises a plurality of photo collaging templates Each collaging template is configured to define sizes and layouts of images of data objects with different types. The server can select a collaging template based on a number of the data objects and type information of the data objects included in the specified coordinating scheme.

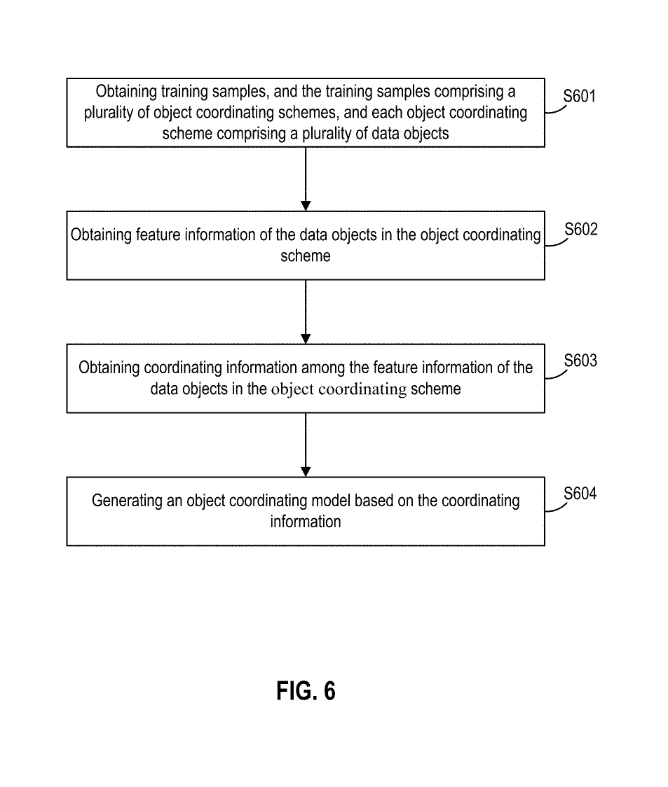

FIG. 6 is a flowchart of an exemplary method for generating an object coordinating template according to embodiments of the present disclosure. The method can specifically comprise the following steps.

In step S601: Obtaining training samples, and the training samples comprise a plurality of known coordinating schemes, and the known coordinating schemes comprise a plurality of data objects.

In step S602: Obtaining the feature attribute information of the type data objects in the known coordinating scheme.

In step S603: Obtaining the coordinating information among the feature attributes based on the feature attribute information of the data objects in the known coordinating scheme.

In step S604: Generating an object coordinating model based on the coordinating information.

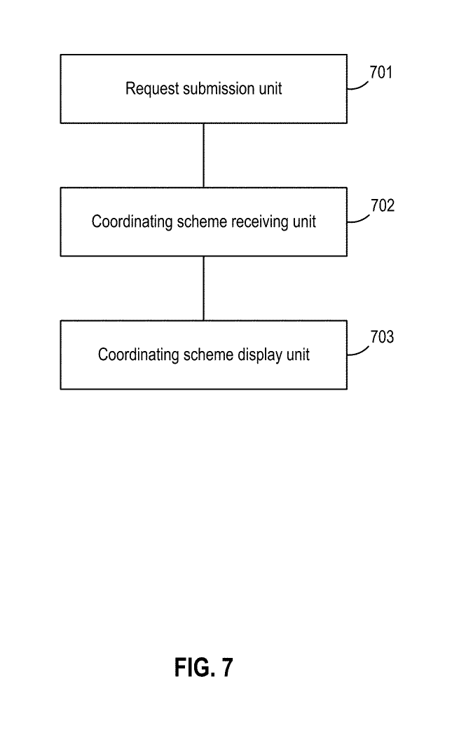

FIG. 7 is a schematic diagram of an exemplary device for generating coordinating information according to embodiments of the present disclosure. The device can specifically comprise the following units.

Request submission unit 701 is used to submit a object coordinating request to a server;

Coordinating scheme receiving unit 702 is used to receive the coordinating scheme returned by the server, wherein, the coordinating scheme comprises data object information for multiple types, and the multiple data objects include a first data object that is the primary coordinating object as well as at least one second data object configured to coordinate with the first data object

Coordinating scheme display unit 703 is used to display the coordinating scheme.

In some embodiments, where clothing is considered the data objects to be coordinated and the coordinating scheme is a clothing matching scheme, the first data object comprises clothing type data objects already purchased by the requester user. Specifically, the first data object comprises data object of clothing types related to the current season purchased by the requester user.

In such embodiments, the clothing matching request can include geographical location information of requester user. Accordingly, the first data object comprises data object of the clothing types related to the current weather conditions of the geographical location purchased by the requester user. In some embodiments, the first data object comprises the clothing type data object specified by the requester user. Or, the first data object comprises a matching temperature that corresponds to a clothing type data object that has preset conditions. Specifically, the object coordinating request contains at least one of geographical location information of the user, occasion information for clothing matching, a spending power of a user, or brand preferences of the user. The first data object comprises at least one of a clothing data object purchased by the user, a clothing data object specified by the user, or a clothing data object with a popularity level that meets a condition. The purchased clothing data object is at least one of being related to a current season, or being related to weather conditions of the geographical location of the user. The second data object is determined based on at least one of weather conditions of the geographical location of the user, the occasion information for clothing matching, the spending power of the user, or the brand preferences of the user.

In some embodiments, the coordinating scheme comprises image information of the plurality of data objects of clothing types as well as the layout information of each image. The coordinating scheme display unit can specifically be used to: display the image information of the plurality of data objects of the types in the coordinating interface according to the layout information. Specifically, the coordinating scheme display unit can also be used to: display suggestion information related to the first data object, and the object information is used to suggest the main coordinating objects of the first data object. Moreover, the coordinating scheme also comprises style description information belonging to the coordinating scheme. The coordinating scheme display unit can also be used to display the style description information. In addition, the coordinating scheme comprises summary information of the data objects. The device also comprises a first selectable item providing unit which is used to display the detail information of the data object in the coordinating scheme. A detail information display unit which is used to respectively display each detail information at the location of the image of each data object when a view request is received through the first selectable item. Moreover, the coordinating scheme also comprises the page link address information of the data object.

The device also comprises: an operating status setup unit which is used to set the area of the image of the data object as operable with the summary information of the data object displayed, a jump unit which is used to jump to and display the details page of the data object when the location of one of the data object images is being operated. Moreover, the coordinating scheme can also comprise information of at least one replaceable data object related to the data object.

The device can also comprise a candidate display unit which is used to add a candidate display area in the coordinating interface and display information for at least one replaceable data object related to the displayed target data object in the candidate display area when one of the target data objects is selected, a switching unit which is used to switch the replaceable data object information in the selection to the location of target data object image in the coordinating scheme when one of the replaceable data objects is selected.

In some embodiments, the replaceable data object information in the coordinating scheme comprises: the thumbnail and large image of the replaceable data object and specifying the size of the data object related to the image size based on the coordinating scheme. The candidate display unit can specifically be used to display a thumbnail of the at least one replaceable data object related to the displayed target data object in the candidate display area. The switching unit can specifically be used to switch the large image of the replaceable data object in the selection to the location of the target data object image in the coordinating scheme. Specifically, the thumbnail image includes a first thumbnail image and a second thumbnail image, and the first thumbnail image size is smaller than the second thumbnail image, and the candidate display area includes a first sub-area and a second sub-area. The candidate display unit can specifically be used to display a first thumbnail image of the replaceable data object in the first sub-area, display a second thumbnail image of some of the replaceable data objects in the second sub-area, and when the preset operation executed by the second sub-area is received, display a second thumbnail image of the other replaceable data objects in the second sub-area.

Moreover, this device can also comprise a status switchover unit which is used to place a second thumbnail image in the second sub-area of the target replaceable data object and a first thumbnail image in the first sub-area in selection status when a target replaceable data object in the second sub-area is selected, a second operation option providing unit which is used to save a second operation option for the replaced coordinating scheme, and a storage unit which is used to submit the replaced coordinating scheme information to the server to be used to save to the storage space of the requester user when a storage request for the replaced coordinating scheme is received through the second operation option.

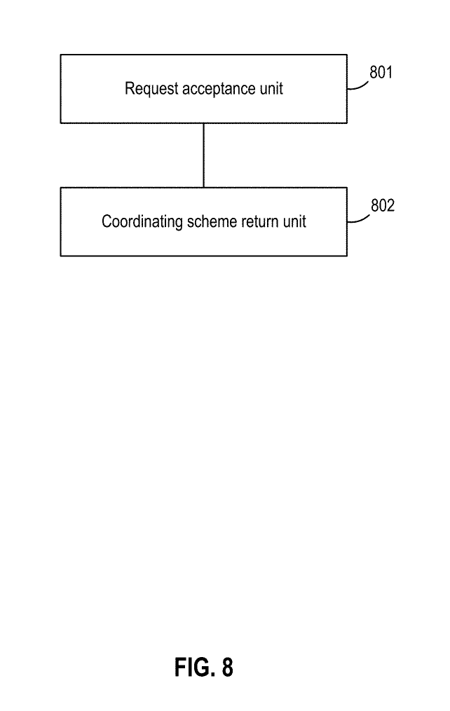

FIG. 8 is a schematic diagram of an exemplary device for generating object coordinating information according to embodiments of the present disclosure. This device can comprise a request receiving unit 801 and a coordinating scheme return unit 802.

The request receiving unit 801 is used to receive an object coordinating request sent by a client.

The coordinating scheme return unit 802 is used to return an object coordinating scheme to the client, wherein, the coordinating scheme comprises information for a plurality of data objects, and the plurality of data objects include a first data object that is the primary coordinating object and at least one second data object configured to coordinate with the first data object.

In some embodiments, prior to returning the coordinating scheme to the client, it also comprises: a first data object determining unit which is used to determine the first data object, a second data object determining unit which is used to determine at least one second data object that can be coordinated with the first data object and generate the coordinating scheme.

Specifically, the first data object specifying unit is specifically used to determine the first data object based on the data object acquired by the user connected to the client.

In some embodiments, the first data object specifying unit can specifically be used to determine the first data object based on data contained in the coordinating request.

In some embodiments, the first data object specifying unit can specifically be used to determine the first data object based on information of the data object with a popularity level that meets a condition.

The second data object determining unit can specifically include a feature attribute obtaining unit which is used to obtain feature information of the first data object, and a coordinating sub-unit which is used to select in a data object information database at least one second data object with a coordinating relationship to the feature which matches the feature attribute information of the first data object using a preset coordinating model.

In some embodiments, wherein clothing is considered the data object to be coordinated and the coordinating scheme is a clothing matching scheme, a weather tag for the clothing type data object is also stored in the data object information database.

The matching sub-unit can also be used to make a selection. The selection can include selecting the at least one second data object with the clothing feature information which matches a weather condition of the geographical location of the user linked to the client. The selection can also include selecting the at least one second data object with a matching relationship to the clothing feature attribute and the weather condition information.

In some embodiments, an occasion tag for the clothing type data object is also stored in the data object information database;

The matching sub-unit can also be used to select at least one second data object with matching relationship to the clothing feature attribute and the location information based on the required location information of the requesting user on the client end, and save a price position tag or brand positioning tag for the clothing type data object in the data object information database.

The matching sub-unit can also be used to select at least one second data object with matching relationship to the clothing feature attribute and the price and/or brand positioning information based on the required price and/or brand positioning information of the requesting user on the client end.

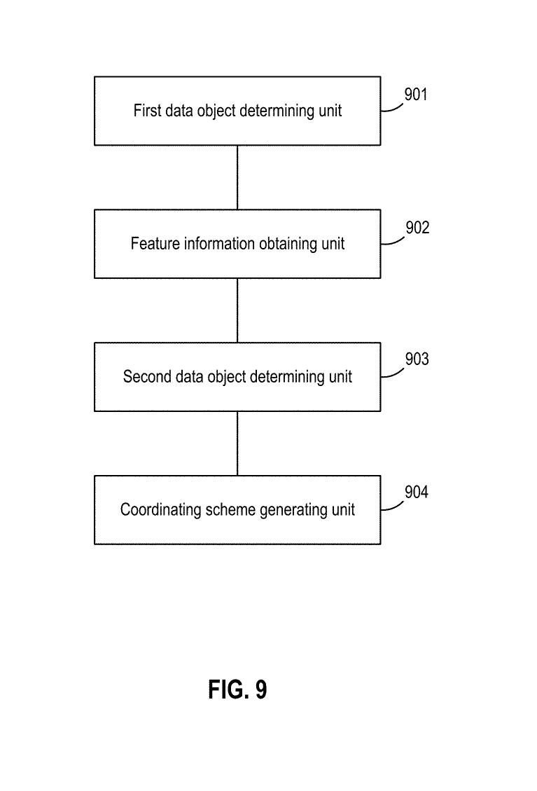

FIG. 9 is a schematic diagram of an exemplary device for generating an object coordinating scheme according to embodiments of the present disclosure. The device can comprise first data object determining unit 901, feature obtaining unit 902, second data object specifying unit 903 and coordinating scheme generating unit 904.

First data object determining unit 901 is configured to determine a first data object.

Feature obtaining unit 902 is configured to obtain feature information of the first data object.

Second data object specifying unit 903 is configured to select in a data object information database at least one second data object with feature information which matches the feature information of the first data object using a preset coordinating model.

Coordinating scheme generating unit 904 is configured to generate a coordinating scheme based on information of the first data object and information of the second data object.

Specifically, the coordinating scheme generating unit is specifically used to create a photo collage with the image of the first data object and the image of the second data object based on a preset collaging template in order to generate the coordinating scheme.

In some embodiments, this device can also comprise a collaging template providing library unit which is used to provide a collaging template library comprising a plurality of collaging templates, and each collaging template is configured to define sizes and layouts of images of data objects with different types, and a collaging template selection unit which is used to select a target collaging template based on the number of data objects included in the specified coordinating scheme and the information for each attribute.

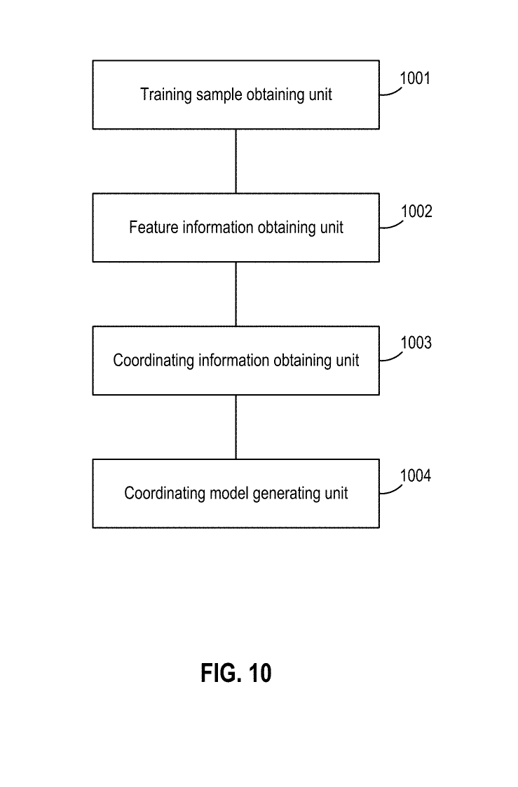

FIG. 10 is a schematic diagram of an exemplary device for generating an object coordinating template

The device can comprise training sample obtaining unit 1001 which is used to obtain training samples, and the training samples comprise a plurality of coordinating schemes, and the coordinating schemes comprise a plurality of data objects, feature attribute information obtaining unit 1002 which is used to obtain feature information of the data object in the coordinating scheme, coordinating relationship obtaining unit 1003 which is used to obtain coordinating information among the feature information of the data objects based on the feature information of the data objects in the coordinating scheme, and coordinating model generating unit 1004 which is used to generate a coordinating model based on the coordinating information.

The embodiments can provide a type of electronic equipment, comprising: one or more memories storing a set of instructions and one or more processors configured to execute the set of instructions to cause the device to perform submitting an object coordinating request to a server, receiving an object coordinating scheme returned by the server, wherein the object coordinating scheme comprises data object information of a plurality of data objects, and the plurality of data objects include a first data object being a primary coordinating object and at least one second data object configured to coordinate with the first data object, and displaying the object coordinating scheme.

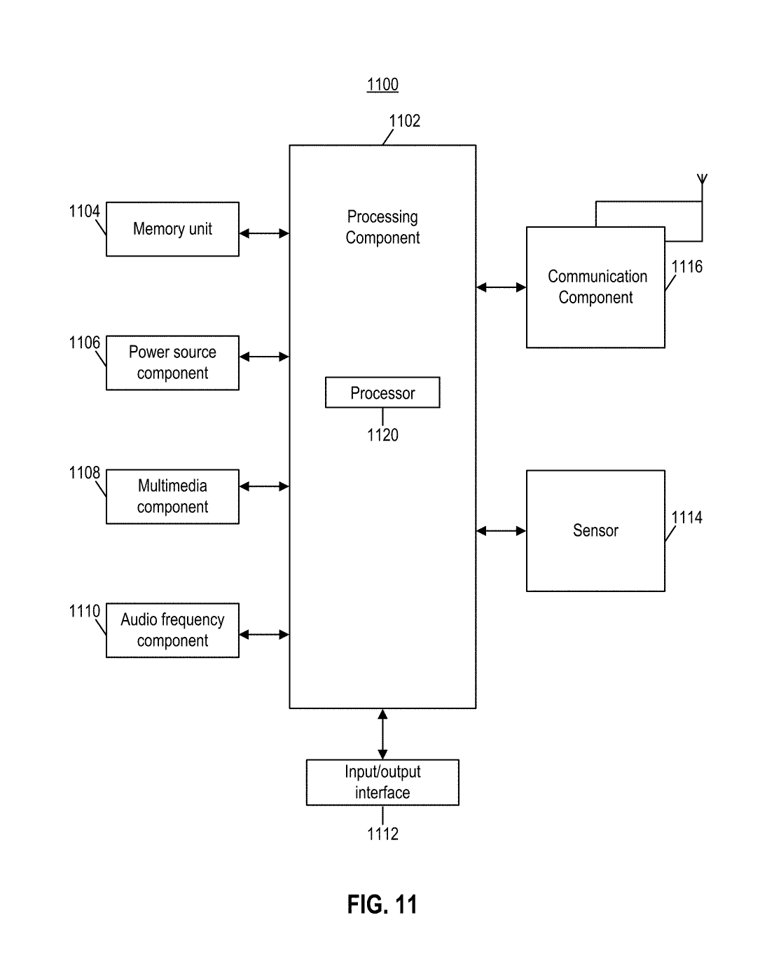

The electronic equipment framework displayed in the example in FIG. 11. The electronic equipment can be one of the above-mentioned devices. For example, equipment 1100 can be a mobile telephone, computer, digital playback terminal, messaging device, game console, tablet, medical equipment, exercise equipment, personal digital assistant, or aircraft, etc.

FIG. 11 is a schematic diagram of an exemplary electronic equipment according to embodiments of the present disclosure. Referring to FIG. 11, equipment 1100 can comprise one or more of the following components: processing component 1102, memory unit 1104, electric power source component 1106, multimedia component 1108, audio frequency component 1110, input/output (I/O) interface 1112, sensor component 1114, and communication component 1116.

Processing component 1102 is configured to control operations of equipment 1100, such as display, telephone calls, digital communication, camera operations, and recording operations. Processing component 1102 can comprise one or more processors 1120 to execute instructions to perform the above-described methods. Moreover, processing component 1102 can comprise one or more modules to facilitate interaction between processing component 1102 and the other components. For example, processing component 1102 can comprise a multimedia module to facilitate interaction between multimedia component 1108 and processing component 1102.

Memory unit 1104 is configured to store data of all types to cause equipment 1100 to perform methods for providing object coordinating information, methods for generating an object coordinating scheme, methods for generating an object coordinating template. Equipment 1100 can be any of the devices performing the above methods according to the embodiments of the disclosure. Examples of the data include any application or method instructions used for operations of equipment 1100, contacts data, telephone directory data, messages, images, and videos, etc. Memory unit 1104 can be any type of volatile or non-volatile storage equipment or combinations of them, such as SRAM, EEPROM, EPROM, PROM, ROM, magnetic memory, flash memory, magnetic disk or compact disk.

Electric power source component 1106 provides power for each component of equipment 1100. Electric power component 1106 can comprise power management systems, one or more power sources, and other components for power generation, management and allocation of equipment 1100.

Multimedia component 1108 comprises an output interface screen between equipment 1100 and the user. In some embodiments, the screen can comprise liquid crystal display (LCD) and touch pad (TP). If the screen comprises a touch pad for receiving input signals from the user. A touch pad comprises one or more touch sensors to sense touch, sliding and touch pad gestures. A touch sensor can not only sense boundaries of touch or sliding movements, it can also detect duration and pressure of the touch or sliding movements. In some embodiments, multimedia component 1108 comprises a front webcam or a rear webcam. When equipment 1100 is in operating mode, such as in a shooting mode or in a video mode, the front webcam or rear webcam can receive external multimedia data. Each front webcam and rear webcam can be a fixed optical lens system or have optical zooming capability.

Audio frequency component 1110 is configured to output or input audio signals. For example, audio frequency component 1110 comprises a microphone (MIC). When equipment 1100 is in an operating mode, such as call mode, record mode, and speech recognition mode, the microphone is configured to receive external audio signals. The audio signals received can be further stored in the memory unit 1104 or sent by the communications component 1116. In some embodiments, the audio frequency component 1110 also comprises a speaker which is used to output an audio signal.

I/O interface 1112 provides an interface between processing component 1102 and a peripheral interface module. The peripheral interface module can be a keyboard, a click wheel or buttons. The buttons can comprise, but are not limited to: home page button, volume button, start button and lock button.

Sensor component 1114 comprises one or more sensors which are used to test status of equipment 1100. For example, sensor component 1114 can detect the on/off status of equipment 1100, relative positioning of the components. The components can be equipment 1100 monitor and keypad. Sensor component 1114 can also detect a location change of equipment 1100 or a component of equipment 1100, presence of user contact with equipment 1100, direction or acceleration/deceleration of equipment 1100 and changes in temperature of equipment 1100. Sensor component 1114 can comprise proximity sensors and be configured to detect the presence of nearby objects when there is no physical contact. Sensor component 1114 can also comprise light sensors, such as CMOS or CCD imaging sensors, which are used in imaging applications. In some embodiments, sensor component 1114 can also comprise accelerometers, gyroscope sensors, magnetic sensors, pressure sensors or temperature sensors. Computer executable instructions for implementing these interactive functions can be configured/stored in one or more computer program products or computer readable storage mediums.

Communication component 1116 is configured to facilitate wired or wireless communications between equipment 1100 and other equipment. Equipment 1100 can access wireless Internet based on communications standards, such Wi-Fi, 2G or 3G, or combinations of these. In one embodiments, communication component 1116 receives external playback management system playback signals or playback-related information from playback channels. In one embodiments, the communication component 1116 also comprises a Near Field Communication (NFC) module to felicitate short range communication. For example, the NFC module can be employed based on Radio Frequency Identification (RFID) technology, Infrared Data Association (IrDA) technology, Ultra-Wideband (UWB) technology, Bluetooth (BT) technology, and other technologies.

In the embodiments, equipment 1100 can be achieved using one or more application-specific integrated circuit (ASIC), digital signal processor (DSP), digital signal processing division (DSPD), programmable logic device (PLD), field programmable data array (FPGA), controller, micro-controller, micro-processor or other electronic component in order to execute the methods described above.

It is appreciated that the embodiments of the present disclosure may be implemented by software in combination with a universal hardware platform such as one or more memories and one or more processors.

In some embodiments, a non-transitory computer readable storage medium containing instructions such as memory unit 1104 is also provided, and the abovementioned instructions can be executed by a device (such as equipment 1100 shown in FIG. 11) for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, any other memory chip or cartridge, and networked versions of the same. The device may include one or more processors (CPUs), an input/output interface, a network interface, and/or a memory.

The embodiments in the specification are described progressively, identical or similar parts of the embodiments may be obtained with reference to each other, and each embodiment emphasizes a part different from other embodiments. Especially, the system or system embodiment provides functionality that is basically similar to the functionality provided by the method embodiment, so it is described simply. The systems and system embodiments described above are merely exemplary. The units described as separate parts may or may not be physically separate, and parts displayed as units may or may not be physical units, may be located in one position, or may be distributed on a plurality of network units. Some or all of the modules may be selected according to achieve the objectives of the solutions of the embodiments.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

Based on the several embodiments provided in the present disclosure, it should be appreciated that the disclosed technical contents may be implemented in another manner. The described apparatus, system, and method embodiments are only exemplary. For example, division of units is merely exemplary division based on the logical functions. Division in another manner may exist in actual implementation. Further, a plurality of units or components may be combined or integrated into another system. Some features or components may be omitted or modified in some embodiments. In addition, the mutual coupling or direct coupling or communication connections displayed or discussed may be implemented by using some interfaces. The indirect coupling or communication connections between the units may be implemented electrically or in another form.

Further, the units described as separate parts may or may not be physically separate. Parts displayed as units may or may not be physical units. They may be located in a same location or may be distributed on a plurality of network units. Some or all of the units may be selected according to actual needs to achieve the objectives of the solutions of the embodiments. In addition, functional units in the embodiments of the present disclosure may be integrated into one processing unit. Each of the units may exist alone physically, or two or more units can be integrated into one unit. The integrated unit may be implemented in a form of hardware or may be implemented in a form of a software functional unit.

It is appreciated that the above descriptions are only exemplary embodiments provided in the present disclosure. Consistent with the present disclosure, those of ordinary skill in the art can incorporate variations and modifications in actual implementation without departing from the principles of the present disclosure. Such variations and modifications shall all fall within the protection scope of the present disclosure.

1. A method for providing object coordinating information, comprising:
submitting an object coordinating request to a server;
receiving an object coordinating scheme returned by the server, wherein the object coordinating scheme comprises data object information of a plurality of data objects, and the a plurality of data objects include a first data object being a primary coordinating object and at least one second data object being configured to coordinate with the first data object;
displaying the object coordinating scheme.

2. The method according to claim 1, wherein
displaying the object coordinating scheme, comprises:
in a coordinating interface, displaying images of the plurality of data objects according to layout information of the images, wherein the images and the layout information of the images are contained in the object coordinating scheme.

3-4. (canceled)

5. The method according to claim 2, further comprising,
providing a first selectable item configured to display detail information of the data object in the object coordinating scheme;
in response to a view request being received through the first selectable item, respectively displaying the detail information on the image of each data object.

6. The method according to claim 5,
further comprising:
setting a status of an area as interactable, wherein the image of the data object is displayed in the area;
jumping to and displaying the detail page of the data object directed by a link provided by detail page link information of the data object in response to the area of one of the data object images being interacted with, wherein the detail page link information is contained in the object coordinating scheme.

7. The method according to claim 2, further comprising:
in response to one of the data objects being selected, providing one or more candidate display areas in the coordinating interface and displaying information of at least one replaceable data object related to the displayed data object in the candidate display area; and
in response to one of the replaceable data objects being selected, replacing the image of the data object with the information of the selected replaceable data object.

8. The method according in claim 7, wherein
the information of the replaceable data object in the object coordinating scheme comprises: one or more thumbnail images and an enlarged image of the replaceable data object, the size of the enlarged image being determined based on the size of the image of the data object related to the replaceable data object in the object coordinating scheme;
displaying information of the at least one replaceable data object comprising:
displaying the thumbnail image of the at least one replaceable data object related to the displayed data object in the candidate display area;
replacing the image of the data object with the information of the selected replaceable data object comprising:
replacing the image of the data object with the enlarged image of the selected replaceable data object.

9. The method according to claim 8, wherein, displaying a thumbnail image of the at least one replaceable data object related to the data object in the candidate display area, comprising:
displaying a first thumbnail image of the one or more thumbnail images of the replaceable data object in a first sub-area of the one or more candidate areas, wherein the size of the first thumbnail image is smaller than the size of the second thumbnail image;
displaying a second thumbnail image of the one or more thumbnail images of some of the replaceable data objects in a second sub-area of the one or more candidate areas, and in response to an operation being received by the second sub-area, displaying a second thumbnail image of the other of the replaceable data objects in the second sub-area.

10. The method according to claim 9, further comprising:
in response to the replaceable data object in the second sub-area being selected, setting as selected the second thumbnail image in the second sub-area of the replaceable data object and the first thumbnail image in the first sub-area.

11. The method according to claim 7, further comprising:
providing a second selectable item for storing the replaced coordinating scheme;
in response to a storage request being received through the second selectable item, submitting the replaced coordinating scheme information to the server such that the replaced coordinating scheme information can be saved in the storage space of the user.

12. The method according to claim 1, wherein the object coordinating request contains at least one of geographical location information of the user, occasion information for clothing matching, a spending power of a user, or brand preferences of the user.

13. The method according to claim 12, wherein
the first data object comprises at least one of a clothing data object purchased by the user, a clothing data object specified by the user, or a clothing data object with a popularity level that meets a condition.

14. The method according to claim 13, wherein
the purchased clothing data object is at least one of being related to a current season, or being related to weather conditions of the geographical location of the user.

15. The method according to claim 12, wherein
the second data object is determined based on at least one of weather conditions of the geographical location of the user, the occasion information for clothing matching, the spending power of the user, or the brand preferences of the user.

16. A method for providing object coordinating information, comprising:
receiving an object coordinating request sent by a client; and
returning an object coordinating scheme to the client, wherein the object, coordinating scheme comprises data object information of a plurality of data objects, and the plurality of data objects comprises a first data object being a primary coordinating object and at least one second data object configured to coordinate with the first data object.

17. The method according to claim 16, further comprising,
prior to returning the object coordinating scheme to the client, determining the first data object;
determining the at least one second data object that can coordinate with the first data object and generating the object coordinating scheme.

18-20. (canceled)

21. The method according to claim 17, wherein,
determining the at least one second data object that can be coordinated with the first data object, comprising:
obtaining feature information of the first data object;
selecting in a data object information database at least one second data object with the feature which matches the feature information of the first data object using an object coordinating model.

22. The method according to claim 21, wherein,
selecting the at least one second data object comprises:
selecting the at least one second data object with clothing feature information which matches a weather condition of a geographical location of the user on the client end, wherein the weather condition is indicated by a weather tag for the clothing data object saved in the database.

23. The method according to claim 21, wherein,
selecting the at least one second data object comprising:
selecting the at least one second data object with the clothing feature which matches the occasion information requested by the user, wherein the occasion information is indicated by an occasion tag for the clothing data object saved in the database.

24. The method according to claim 21, wherein,
selecting the at least one second data object comprising:
selecting the at least one second data object with the clothing feature which matches at least one of the price information, or brand positioning information requested by the user, wherein the price information is indicated by a price tag for the clothing data object saved in the database, and the brand positioning information is indicated by a brand positioning tag for the clothing data object saved in the database.

25-32. (canceled)

33. A non-transitory computer readable medium that stores a set of instructions that is executable by at least one processor of a computer to cause the computer to perform a method for providing object coordinating information, the method comprising:
submitting an object coordinating request to a server;
receiving an object coordinating scheme returned by the server, wherein the object coordinating scheme comprises data object information of a plurality of data objects, and the plurality of data objects include a first data object being a primary coordinating object and at least one second data object being configured to coordinate with the first data object;
displaying the object coordinating scheme.

34-47. (canceled)
